(19) United States
(12) Patent Application Publication
(10) Pub. No.: US 2024/0198788 A1
(43) Pub. Date: Jun. 20, 2024

(54) EXPANDED FUEL FILL PIPE AND METHOD OF MAKING SAME

(71) Applicant: Fluid Routing Solutions, LLC, Madison Heights, MI (US)

(72) Inventor: Richard Charles St. John, Big Rapids, MI (US)

(73) Assignee: Fluid Routing Solutions, LLC, Madison Heights, MI (US)

(21) Appl. No.: 18/287,787

(22) PCT Filed: Apr. 20, 2022
(86) PCT No.: PCT/US2022/025488

§ 371 Date: Oct. 20, 2023

Related U.S. Application Data
(60) Provisional application No. 63/177,985, filed on Apr. 22, 2021.

(51) Int. Cl. B60K 15/04; B21D 51/38

(52) U.S. Cl. CPC B60K 15/04; B21D 51/38; B60K 2015/047

(57) ABSTRACT

A fuel filler neck assembly and a method of making a funnel for a fuel fill tube assembly includes forming a tube blank with a first punch tool, forming the tube blank with a second punch tool, forming the tube blank with a third punch tool, forming the tube blank with a fourth punch tool, and forming the tube blank with a trim ring and trim insert.

### BACKGROUND

The present disclosure relates to fuel filler tubes and related assemblies for filling a vehicle with fuel.

Fuel filler tube assemblies have been around at least since the dawn of gasoline-powered vehicles. In general, a fuel filler tube assembly is a conduit for routing fuel from a filler neck to a fuel tank. The filler neck is generally positioned in a convenient location so that it can be readily accessed during refueling operations. The filler neck is fluidly coupled to the fuel tank via a hose or other conduit. A cap or cover is often provided for closing off the filler neck between refueling operations.

Past fuel filler tube assemblies often employ a mounting flange surrounding the filler neck for mounting and securing the assembly to a body panel or other component of a vehicle. The mounting flange is typically telescoped over the filler neck and secured in place via various welding methods. Then a filler neck insert is installed in the fuel filler neck, and the rim of the opening of the filler neck is rolled down to join/secure the insert with the filler neck.

The prior art fuel filler tube assembly requires certain manufacturing steps, such as rolling the filler neck rim after installation of the mounting flange and designed fracture points, that complicate the manufacturing process and increase costs.

### BRIEF DESCRIPTION

Aspects of the present disclosure are directed to a method of making a funnel for a fuel filler assembly from a tube blank, and a funnel made in accordance with the method.

In accordance with one aspect of the present disclosure, a method of making a funnel for a fuel fill tube assembly comprises forming a tube blank with a first punch tool, forming the tube blank with a second punch tool, forming the tube blank with a third punch tool, forming the tube blank with a fourth punch tool, and forming the tube blank with a trim ring and trim insert.

The funnel includes a plurality of cylindrical portions each separated by a respective tapered transition portion, the plurality of cylindrical portions decreasing in diameter along a length of the funnel from a largest diameter cylindrical portion to a smallest diameter cylindrical portion, and the funnel includes a large opening at a first end and a small opening at a second end, a flange surrounding the large opening, and a pair of flats formed on opposite sides of the largest cylindrical portion.

The tube blank can include a 25.4 mm diameter tube having 0.8 mm wall thickness. The first hit punch can be a 1.275-inch diameter punch with a 40-degree transition angle made from 954 Aluminum Bronze. The second hit punch can be a 1.6-inch diameter punch with a 40-degree transition angle made from 954 Aluminum Bronze. The third hit punch can be a 1.856-inch diameter punch with a 40-degree transition angle on a nose of the punch and a 1.943-inch diameter 34-degree transition angle on a secondary diameter of the punch, a 2.185-inch diameter flare with a 60-degree transition angle with a flat cut at the same orientation as a weld seam of the tube blank, made from 954 Aluminum Bronze. The fourth hit punch can be a 2.185-inch diameter flare with a 60-degree transition angle full diameter. Forming the tube blank with a trim ring and trim insert can include using an Eagle Endform Machine. A wall thickness of the funnel after the fourth hit can be within a range of between 0.04 in and 0.02 in, and preferably 0.026 in. The method can further include using Richdraw 5405 lubricant in a Manchester 4-hit tube end former.

In accordance with another aspect of the present disclosure, a funnel for a fuel fill tube assembly comprises a plurality of cylindrical portions each separated by a respective tapered transition portion, the plurality of cylindrical portions decreasing in diameter along a length of the funnel from a largest diameter cylindrical portion to a smallest diameter cylindrical portion, wherein the funnel includes a large opening at a first end and a small opening at a second end, a flange surrounding the large opening, and a pair of flats formed on opposite sides of the largest cylindrical portion.

The funnel can be tubular and can have a wall thickness within a range of between 0.04 in and 0.02 in, and preferably 0.026 in.

### BRIEF DESCRIPTION OF THE DRAWINGS

FIG. 1 is a perspective view of an exemplary fuel filler tube assembly in accordance with the present disclosure;

FIG. 2 is a side view of an exemplary funnel in accordance with the present disclosure;

FIG. 3 is a flow diagram illustrating an exemplary method in accordance with the present disclosure;

FIG. 4A is top side view of an exemplary tube blank in a forming machine in accordance with the present disclosure;

FIG. 4B is perspective view of an exemplary tube blank in a forming machine in accordance with the present disclosure;

FIG. 4C is a side view of an exemplary tube blank in a forming machine in accordance with the present disclosure;

FIG. 4D is an end view of an exemplary tube blank in a forming machine in accordance with the present disclosure;

FIG. 5A is a perspective view of a first hit tool in accordance with the present disclosure;

FIG. 5B is a side view of the first hit tool in accordance with the present disclosure;

FIG. 5C is a perspective view of the first hit tool in the forming machine in accordance with the present disclosure;

FIG. 5D is a side view of the partially formed tube blank after forming with the first hit tool;

FIG. 6A is a perspective view of a second hit tool in accordance with the present disclosure;

FIG. 6B is a side view of the second hit tool in accordance with the present disclosure;

FIG. 6C is a perspective view of the second hit tool in the forming machine in accordance with the present disclosure;

FIG. 6D is a side view of the partially formed tube blank after forming with the second hit tool;

FIG. 7A is a perspective view of a third hit tool in accordance with the present disclosure;

FIG. 7B is a side view of the third hit tool in accordance with the present disclosure;

FIG. 7C is a perspective view of the third hit tool in the forming machine in accordance with the present disclosure;

FIG. 7D is a side view of the partially formed tube blank after forming with the third hit tool;

FIG. 8A is a perspective view of a fourth hit tool in accordance with the present disclosure;

FIG. 8B is a side view of the fourth hit tool in accordance with the present disclosure;

FIG. 8C is a perspective view of the fourth hit tool in the forming machine in accordance with the present disclosure;

FIG. 8D is a side view of the partially formed tube blank after forming with the fourth hit tool;

FIG. 9A is a perspective view of a trim ring in accordance with the present disclosure;

FIG. 9B is a perspective view of an insert in accordance with the present disclosure;

FIG. 9C is a perspective view of the trim ring and insert in an end forming machine in accordance with the present disclosure; and

FIG. 9D is a side view of the fully formed tube blank.

### DETAILED DESCRIPTION

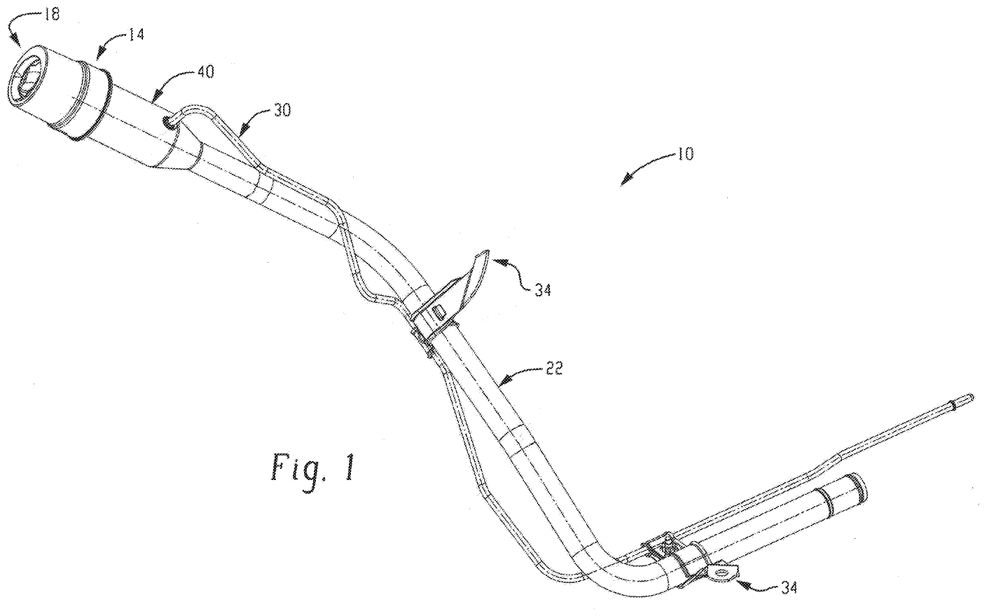

In FIG. 1, an exemplary fuel filler tube assembly in accordance with a first embodiment of the present disclosure is illustrated and identified generally by reference numeral 10. The fuel filler tube assembly 10 generally includes a fuel filler neck 14 (e.g., a tubular fuel fill conduit) having a mouth 18 for receiving a fuel dispensing nozzle (not shown) in conventional fashion. The fuel filler neck 14 is coupled to a tube 22 which in turn is coupled to a fitting of a fuel tank (not shown) for delivering fuel dispensed by a dispensing nozzle into the fuel filler neck 14 to the fuel tank. The fuel filler tube assembly 10 further includes a vent line or recirculation line 30, depending on the application (e.g., diesel or gas) for venting or recirculating vapors from the associated fuel tank. Various brackets 34 are provided for mounting and supporting the assembly 10 to a vehicle.

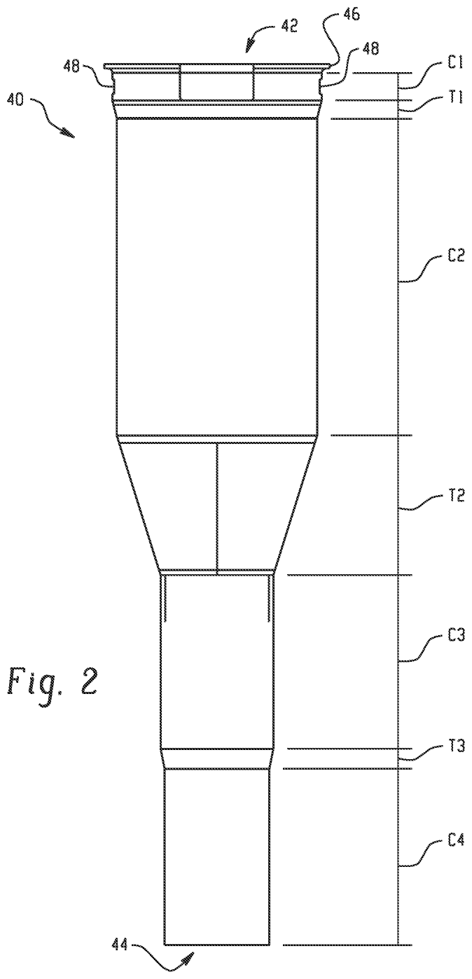

With additional reference to FIG. 2, the fuel filler neck 14 includes a funnel 40 having a large opening 42 forming at least a portion of the mouth 18 of the fuel filler tube assembly 10. The funnel 40 reduces in diameter along its length from the large opening 42 to a small opening 44 which is configured to be connected to the tube 22. To this end, the funnel 40 includes several cylindrical portions C1, C2, C3 and C4 separated by respective tapered e.g., frusto-conical transition portions T1, T2 and T3. As will be appreciated, the cylindrical portion C1 has the largest diameter, which each successive cylindrical portion being of a reduced diameter. A collar or flange 46 surrounds the large opening 42, and a pair of flats 48 are formed on opposite sides of cylindrical portion C1.

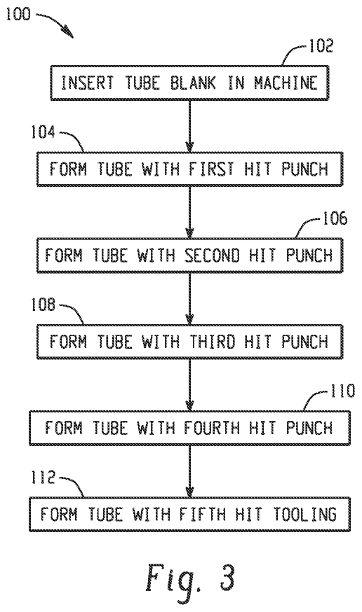

Turning to FIG. 3, a method 100 of making the funnel 40 is illustrated. In general, the method 100 includes four expansion steps and one trim step. In process step 102, a tube blank is inserted into a press. In process step 104, the tube blank is formed with a first hit punch. In process step 106, the partially formed tube is formed with a second hit punch. In process step 108, the partially formed tube is formed with a third hit punch. In process step 110, the partially formed tube is formed with a fourth hit punch. In process step 112, the partially formed tube is formed with a trim ring and insert. With reference to the remaining figures, each of the process steps will be described in more detail.

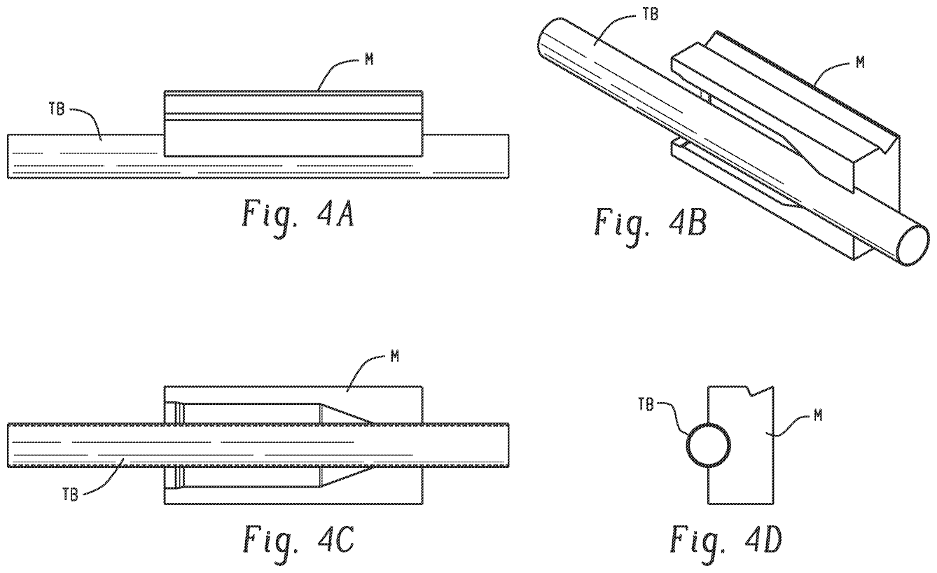

In FIGS. 4A-4D, a tube blank TB is inserted into the forming machine M as outlined in process step 102. In an embodiment, the tube blank TB may be a piece of metal formed into a tube by rolling opposite longitudinal edges of the metal together, and welding the opposite longitudinal edges together along a weld seam. In one exemplary embodiment, the tube blank TB is a 436 stainless steel tube having a 25.4 mm diameter and a 0.8 mm wall thickness and the forming machine is a Manchester 4-hit tube end former adapted to carry out process steps 102, 104, 106 and 108. Richdraw 5405 lubricant is supplied and the machine M is configured for a 1 inch per second feed rate.

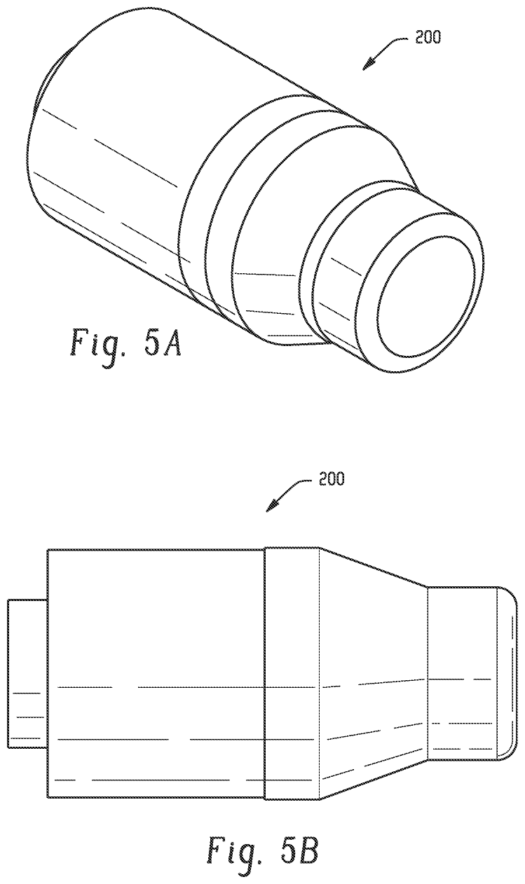

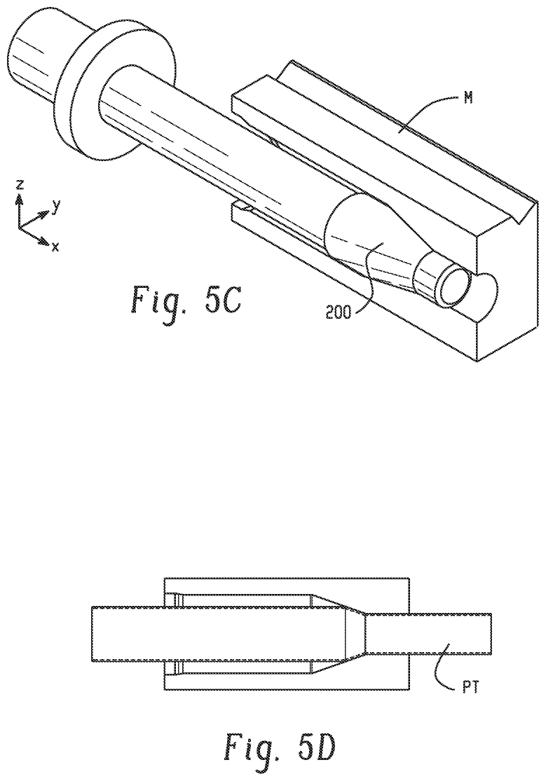

In FIGS. 5A and 5B, a first hit punch 200 for forming the tube blank TB in accordance with process step 104 is illustrated. In particular, FIG. 5B sets forth particular dimensions of the first hit punch 200 in accordance with the present disclosure. In one example, the first hit punch 200 is a 1.275-inch diameter punch with a 40-degree transition angle made from 954 Aluminum Bronze.

FIG. 5C illustrates the first hit punch 200 within the machine M during process step 104. FIG. 5D illustrates the partially formed tube PT after process step 104.

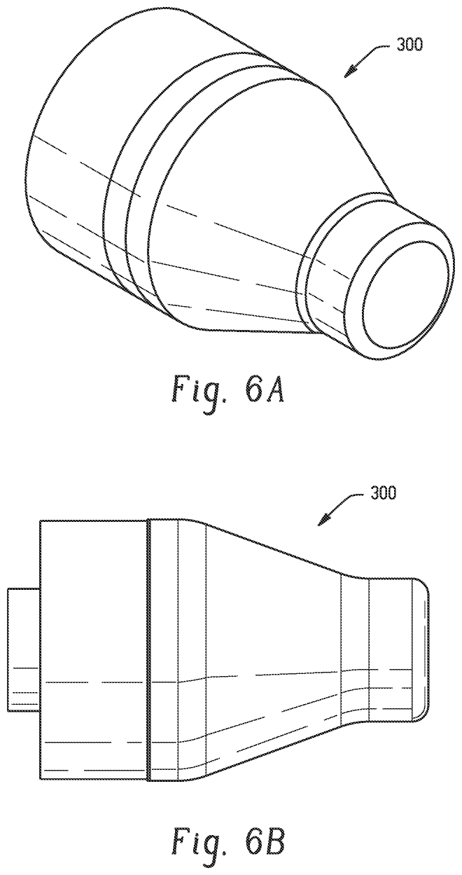

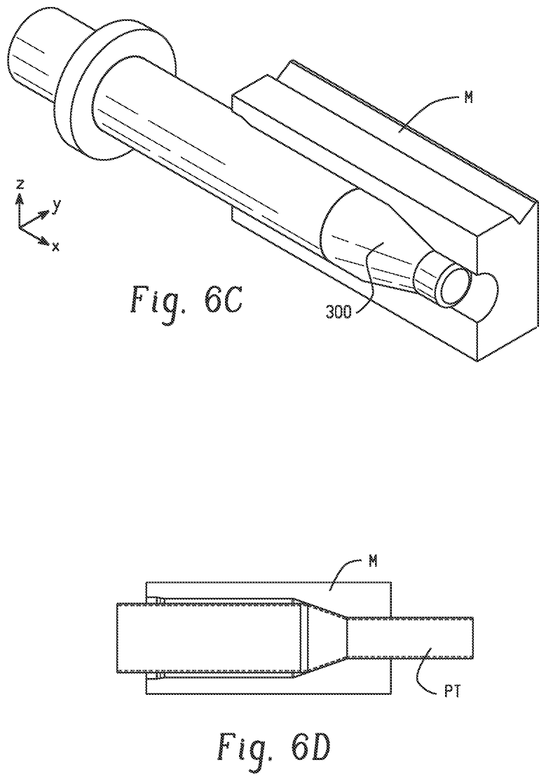

In FIGS. 6A and 6B, a second hit punch 300 for forming the partially formed tube PT in accordance with process step 106 is illustrated. In particular, FIG. 6B sets forth particular dimensions of the second hit punch 300 in accordance with the present disclosure. In one example, the second hit punch 300 is a 1.6-inch diameter punch with a 40-degree transition angle made from 954 Aluminum Bronze.

FIG. 6C illustrates the second hit punch 300 within the machine M during process step 106. FIG. 6D illustrates the partially formed tube PT after process step 106.

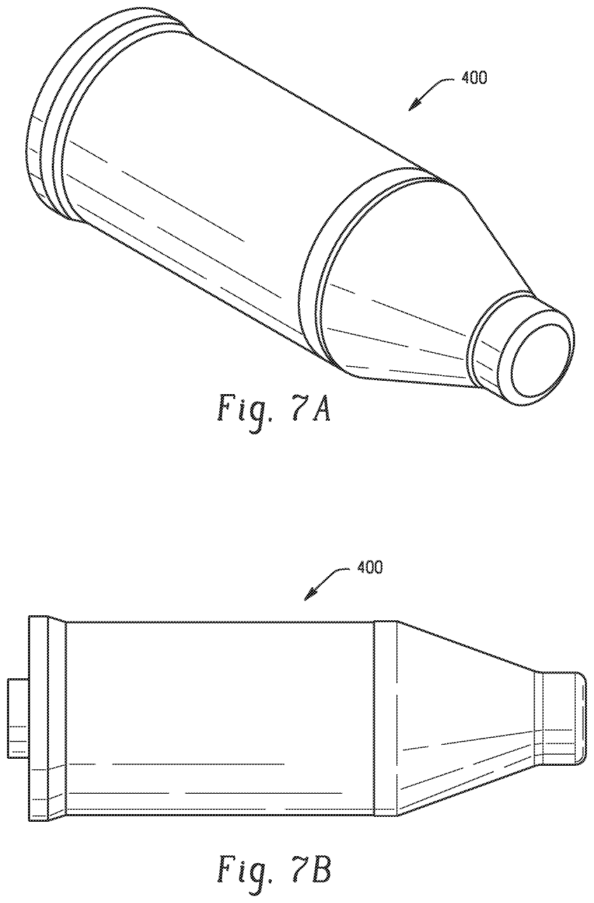

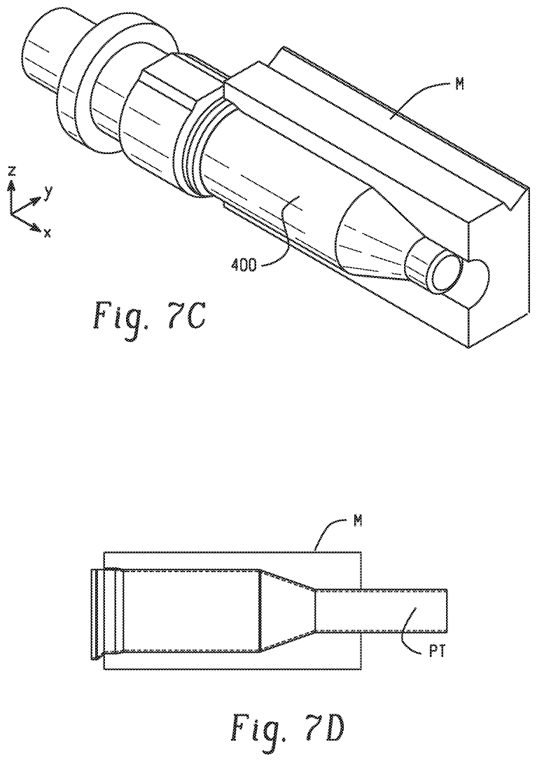

In FIGS. 7A and 7B, a third hit punch 400 for forming the partially formed tube PT in accordance with process step 108 is illustrated. In particular, FIG. 7B sets forth particular dimensions of the third hit punch 400 in accordance with the present disclosure. In one example, the third hit punch 400 is a 1.856-inch diameter punch with a 40-degree transition angle on the nose and a 1.943-inch diameter 34-degree transition angle on the secondary diameter, a 2.185-inch diameter flare with a 60-degree transition angle with a flat cut at the same orientation as the where a weld seam is on the tube blank, made from 954 Aluminum Bronze. FIG. 7C illustrates the third hit punch 400 within the machine M during process step 108. FIG. 7D illustrates the partially formed tube PT after process step 108.

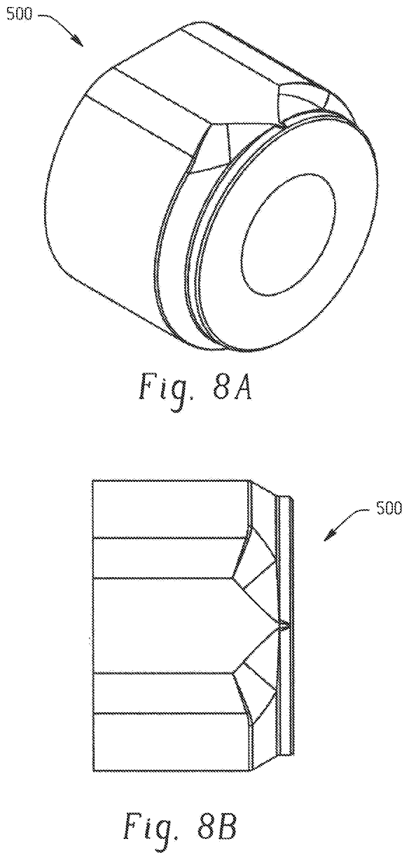

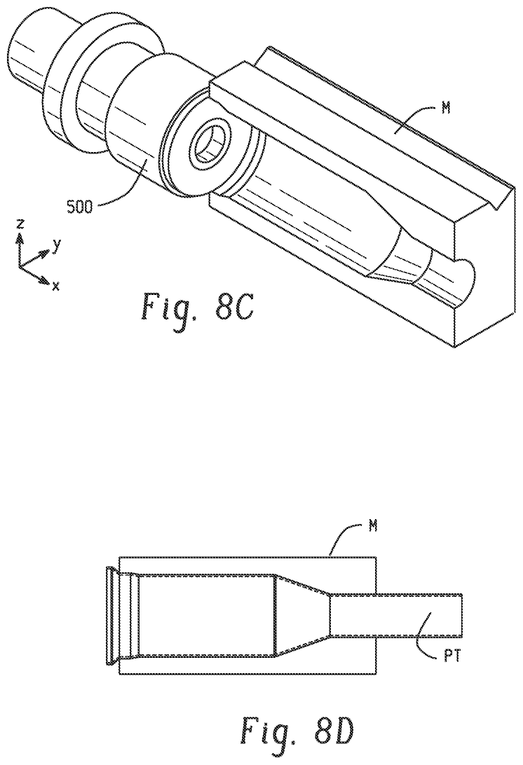

In FIGS. 8A and 8B a fourth hit punch 500 for forming the partially formed tube PT in accordance with process step 110 is illustrated. In particular, FIG. 8A sets forth particular dimensions of the fourth hit punch 500 in accordance with the present disclosure. In one example, the fourth hit punch 500 is a 2.185-inch diameter flare with a 60-degree transition angle full diameter. FIG. 8C illustrates the fourth hit punch 500 within the machine M during process step 110. FIG. 8D illustrates the partially formed tube PT after process step 110.

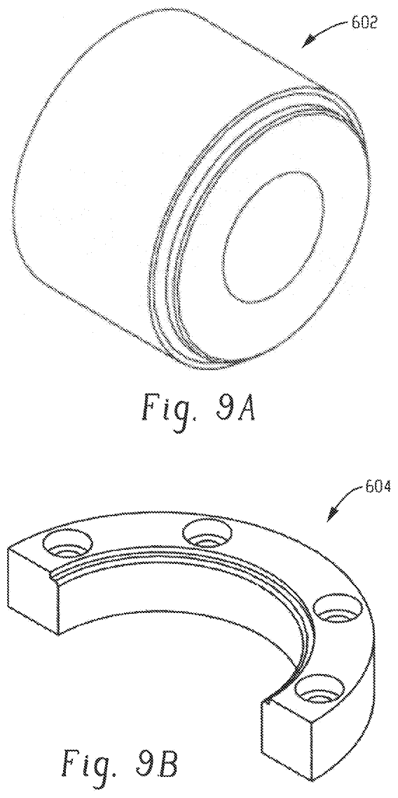

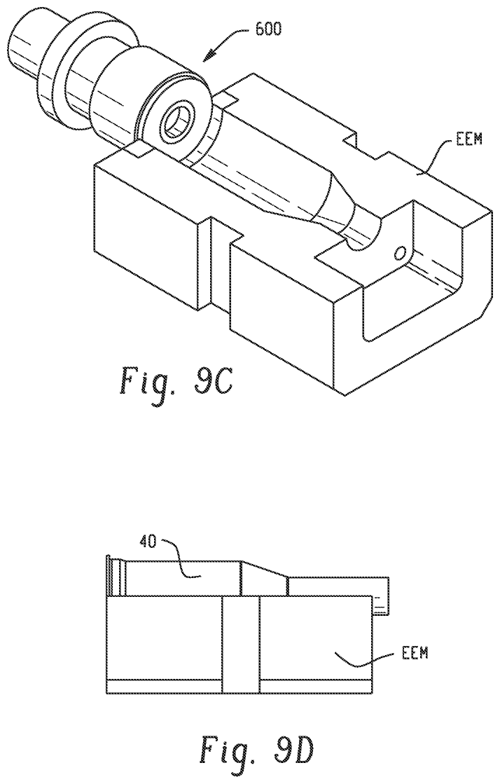

In FIGS. 9A and 9B, a trim ring 602 and insert 604 for forming the partially formed tube PT in accordance with process step 112 is illustrated. In particular, FIGS. 9A and 9B set forth particular dimensions of the trim ring 602 (2.160″ trim diameter) and insert 604 (2.165″ trim diameter) in accordance with the present disclosure. In one exemplary embodiment, an Eagle Endform Machine EEM is utilized for process step 112. FIG. 9C illustrates the trim ring 602 and insert 604 within the Eagle Endform Machine EEM during process step 112. FIG. 9D illustrates the funnel 40 after process step 112.

In one exemplary embodiment, the wall thickness of the completed component (e.g., after the fourth hit) is within a range of between 0.04 in and 0.02 in, and more particularly about 0.026 in.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method of making a funnel for a fuel fill tube assembly comprising:
forming a tube blank with a first punch tool;
forming the tube blank with a second punch tool;
forming the tube blank with a third punch tool;
forming the tube blank with a fourth punch tool; and
forming the tube blank with a trim ring and trim insert;
wherein the funnel includes a plurality of cylindrical portions each separated by a respective tapered transition portion, the plurality of cylindrical portions decreasing in diameter along a length of the funnel from a largest diameter cylindrical portion to a smallest diameter cylindrical portion, and wherein the funnel includes a large opening at a first end and a small opening at a second end, a flange surrounding the large opening, and a pair of flats formed on opposite sides of the largest cylindrical portion.

2. The method of claim 1, wherein the tube blank includes a 25.4 mm diameter tube having 0.8 mm wall thickness.

3. The method of claim 2, wherein the first hit punch is a 1.275-inch diameter punch with a 40-degree transition angle made from 954 Aluminum Bronze.

4. The method of claim 3, wherein the second hit punch 300 is a 1.6-inch diameter punch with a 40-degree transition angle made from 954 Aluminum Bronze.

5. The method of claim 4, wherein the third hit punch is a 1.856-inch diameter punch with a 40-degree transition angle on a nose of the punch and a 1.943-inch diameter 34-degree transition angle on a secondary diameter of the punch, a 2.185-inch diameter flare with a 60-degree transition angle with a flat cut at the same orientation as a weld seam of the tube blank, made from 954 Aluminum Bronze.

6. The method of claim 5, wherein the fourth hit punch is a 2.185-inch diameter flare with a 60-degree transition angle full diameter.

7. The method of claim 6, wherein forming the tube blank with a trim ring and trim insert includes using an Eagle Endform Machine.

8. The method of claim 7, wherein a wall thickness of the funnel after the fourth hit is within a range of between 0.04 in and 0.02 in.

9. The method of claim 8, wherein the wall thickness of the funnel after the fourth hit is 0.026 in.

10. The method of claim 9, further comprising using Richdraw 5405 lubricant in a Manchester 4-hit tube end former.

11. A funnel for a fuel fill tube assembly formed by the method of claim 1, wherein the funnel is of a unitary one-piece construction.

12. A funnel for a fuel fill tube assembly comprising:
a plurality of cylindrical portions each separated by a respective tapered transition portion, the plurality of cylindrical portions decreasing in diameter along a length of the funnel from a largest diameter cylindrical portion to a smallest diameter cylindrical portion, wherein the funnel includes a large opening at a first end and a small opening at a second end, a flange surrounding the large opening, and a pair of flats formed on opposite sides of the largest cylindrical portion.

13. The funnel of claim 12, wherein the funnel is tubular and has a wall thickness within a range of between 0.04 in and 0.02 in.

14. The funnel of claim 13, wherein the wall thickness is 0.026 in.

15. The funnel of claim 14, wherein the funnel is of a unitary one-piece construction.
